(19) United States
(12) Patent Application Publication
(10) Pub. No.: US 2007/0106686 A1
(43) Pub. Date: May 10, 2007

(54) Unstructured data editing through category comparison

(75) Inventors: James Shank, Highlands Ranch, CO (US); William H. Inmon, Castle Rock, CO (US)

Correspondence Address: Fountainhead Law Group, PC, Ste. 509, 900 Lafayette St., Santa Clara, CA, 95050, US

(73) Assignee: Inmon Data Systems, Inc., Castle Rock, CO (US)

(21) Appl. No.: 11/586,898

(22) Filed: Oct. 25, 2006

Related U.S. Application Data
(60) Provisional application No. 60/729,830, filed on Oct. 25, 2005.

(51) Int. Cl. G06F 7/00

(52) U.S. Cl. 707/102

(57) ABSTRACT

Embodiments of the present invention include methods for editing and scanning unstructured data and text by using one or more external categories of data for the purpose of finding words and phrases in the unstructured environment which correspond to words and phrases in the external category. External categories of data are words and phrases that relate to the external category. External categories can be made for practically any subject. When a match (“hit”) is found, an output record is written to a table or a file. The output record may include the document name, the word that was a hit, and the external category. The process of using external categories of data is done either directly or indirectly to unstructured data.

### CROSS-REFERENCE TO RELATED APPLICATIONS

This invention claims the benefit of priority from U.S. Provisional Application No. 60/729,830, filed Oct. 25, 2005, entitled “Unstructured Data Editing Through Category Comparison.”

### BACKGROUND

The present invention relates to processing unstructured and structured data, and in particular, to unstructured data editing through category comparison.

Unstructured data typically comes in the form of email, transcripted telephone conversations, spreadsheets, documents, letters, and other forms. Individuals and corporations have used unstructured data for a long time. As the name suggests, there is no structure to unstructured data. There are no rules for writing emails. There are no rules for having a telephone conversation. Instead with unstructured data everything is free form.

Juxtaposed to unstructured data is structured data. Structured data is data that is formatted into records, tables and attributes. Typical computerized operating systems and database management systems operate on structured data. Structured records are typically placed in a file. Once in a file or a database, the records can be accessed and used for a variety of purposes. With structured data there is a regularity of the contents of the data. The same type of data appears and reappears in the different records. Structured data is ideal for computerized transaction processing, where bank transactions, airline reservations, insurance claims, manufacturing assembly work and so forth are executed.

For years organizations have had both kinds of systems in their environment—unstructured data and structured data. For years these different environments have grown up beside each other. But there has been very little interaction between these environments. It is as if the two environments operated in complete isolation from each other. There is however great value in being able to merge and intertwine these two environments. Many different business opportunities emerge that would have not been possible had the two environments remained separate. As one simple example of the opportunities that arise when the two worlds are merged together, consider CRM—customer relationship management. In customer relationship management the organization attempts to form a close relationship with its customers and its prospects. The organization collects demographic data about the customer. But when communications—emails, telephone conversations, other documents—are added to the fray, the ability to get to know the customer is exponentially enhanced. And emails, telephone conversations, and documents are all forms of unstructured information. Therefore, for organizations that want to engage in CRM, adding unstructured data to the structured CRM environment enables entirely new and powerful types of processing. There are many other important examples of possibilities of applications when the gap between structured data and unstructured data is bridged. Other applications include monitoring of compliance, such as compliance to Sarbanes Oxley, HIPAA and Basel II, the enforcement of standards, and so forth.

There are many problems associated with merging structured data and unstructured data. One of the major problems is the internal organization of the data itself. In a word, structured data is highly controlled and disciplined. There is strict control over structured data. But there is little or no control or discipline for unstructured data. The result is that when the two types of data are merged, there is a colossal mismatch. If you want anything meaningful, you simply do not merge structured data and unstructured data together. In order to have any meaningful merger of structured and unstructured data, it is necessary to carefully manipulate the unstructured data (e.g., text) so that the unstructured data can be placed in a form and format that is compatible with and useful to structured data.

One of the many problems of preparing unstructured data for merger with structured data is that of determining what words and phrases in the unstructured text are relevant and useful to business problems. This is especially important in light of the many different meanings of the same word or phrase in the English language. For example, the word—“book” can mean very different things. The meaning of “I read a book on the airplane trip.” is quite different from “I was booked into jail last night.” The English language is full of such homographs. What is needed is a way to resolve the different meanings of words and to relate those words to business problems and issues.

Thus, there is a need for improved the bridge between unstructured and structured data. The present invention solves these and other problems by providing unstructured data editing through category comparison.

### SUMMARY

Embodiments of the present invention include techniques for unstructured data editing through category comparison. In one embodiment, the present invention includes a method of processing unstructured data comprising specifying a first plurality of words or phrases corresponding to a category, accessing unstructured data comprising a second plurality of words or phrases, comparing the unstructured data against each of the specified words or phrases, associating at least a portion of the unstructured data with the category if one or more of the specified words or phrases matches at least one word or phrase in the portion of the unstructured data, and generating a structured data output.

In one embodiment, the structured data output comprises an identification of an unstructured document, a matching word or phrase, and a name of the category.

In one embodiment, the structured data output comprises at least a portion of the unstructured data, at least one matching word or phrase in the unstructured data and the category.

In one embodiment, the structured data output is a structured record.

In one embodiment, the structured data output is generated in a list.

In one embodiment, the structured data output is generated in a database.

In one embodiment, the structured data output is generated in a table.

In one embodiment, the method further comprises reading the unstructured data into a file, and accessing the unstructured data from the file.

In one embodiment, the method further comprises reading the unstructured data directly from the unstructured data source.

In one embodiment, the unstructured data comprises a plurality of emails.

In one embodiment, the unstructured data comprises a plurality of spreadsheets.

In one embodiment, the unstructured data comprises plurality of transcribed telephone conversations.

In one embodiment, the unstructured data comprises one or more electronic files comprising a plurality of words or phrases.

In one embodiment, the unstructured data comprises textual data.

In one embodiment, the category comprises accounting.

In one embodiment, the category comprises finance.

In one embodiment, the category comprises sales.

In one embodiment, the category comprises Sarbanes Oxley.

In one embodiment, the category comprises manufacturing.

In one embodiment, the category comprises marketing.

In one embodiment, the category comprises human resources.

In one embodiment, the category is generated from the unstructured data.

In one embodiment, the category is an external category.

In one embodiment, the category comprises a name and a plurality of associated words or phrases.

The following detailed description and accompanying drawings provide a better understanding of the nature and advantages of the present invention.

### BRIEF DESCRIPTION OF THE DRAWINGS

FIG. 1 illustrates the structured and the unstructured environments.

FIG. 2 illustrates the bridge that is needed in order to cross the gap between the two environments.

FIG. 3 illustrates text gathered from a wide variety of unstructured sources.

FIG. 4 illustrates two categories formed from the text found in the unstructured environment.

FIG. 5 illustrates an external category.

FIG. 6 illustrates that external categories can come from anywhere.

FIG. 7 illustrates example external categories.

FIG. 8 illustrates direct and indirect techniques for the usage of and execution against an external category.

FIG. 9 shows the dynamics of a direct external category search.

FIG. 10 shows the dynamics of an indirect external category search.

FIG. 11 shows that multiple external categories used during an unstructured data search.

FIG. 12 shows that the same word may appear in more than one external category.

FIG. 13 shows that external categorization processing can occur in conjunction with other unstructured editing.

FIG. 14 shows the content of the output from the external data matching process.

### DETAILED DESCRIPTION

Described herein are systems and methods for bridging data between an unstructured and structured environment. In one embodiment, the present invention includes using external categories for the purpose of understanding what is inside unstructured text. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

Embodiments of the present invention include unstructured bridging software that may be used to capture, organize, store, and display unstructured data and prepare that unstructured data for the purpose of integrating it with and sending it to the structured environment. The editor for this purpose is called the “foundation” or the “editor.” In particular, the foundation can access many forms of unstructured data, including spreadsheets, transcribed telephone conversations, documents, emails, and many other forms of textual unstructured information. In one embodiment, at the point of accessing unstructured data, a lookup may be performed against words and phrases in external or internal categories of data. For example, one or more words or phrases corresponding to a particular category may be specified. If the foundation software finds a match between a word or phrase in unstructured data and a specified word or phase, the word that has been matched, the document id, and the external category name, for example, may be written out to a simple list or data base. The match is called a “hit.” The output table is then available for processing in the structured environment.

Embodiments of the present invention include methods of scanning and editing unstructured data for the purpose of comparing the unstructured data against words and phrases found in the external categories which have been constructed by the organization. The invention may include several components: one or more external categories (e.g., a list of words and phrases which are relevant to or important to the topic of the external category), a body of unstructured text, an editor program which does the comparisons, and an output list of the “hits,” for example.

Once unstructured text is ready for processing, the unstructured text is examined a word and phrase at a time to determine if there is a match with any word in the words and phrases found in the external categories. If a match is found, the word that has been matched, its source document, and its external category may be written to the output table or database. In one embodiment, the present invention uses the technique of external categorization matching against unstructured data.

Two kinds of categorizations of text can be created—an internal categorization and an external categorization. The first kind of categorization—internal categorization—is created by looking only at the words found in the unstructured environment. In an internal categorization the words inside the unstructured environment are taken and manipulated to create the major “theme” or categories of data. Internal categorizations differ from external categorizations. An external categorization of data is created externally to the text or data found inside the unstructured text. The external data can come from anywhere. Indeed there may be no match between any words or phrases found in the external categorization and the unstructured data or text. There may also be a significant intersection between the two environments.

The technique of external category processing against unstructured data for the purpose of understanding the unstructured data begins with an external category. An external category has a name such as Sarbanes Oxley, accounting, human resources, etc. The name reflects the general orientation of the words that will be found in the category. The external category contains a list of words and phrases. The words and phrases are all essential and/or important language relevant to the external category. For example, the external category for Sarbanes Oxley might have the words and phrases “promise to deliver”, “contingent sale”, “delayed payment”, unrecognized revenue”, and so forth. Or the external category for human resources might have the words and phrases “race”, “background”, “education”, “GPA”, “college degree”, and so forth. The purpose of placing words and phrases into an external category is to identify words and phrases that are important to a topic that are in the unstructured document that is being searched or otherwise analyzed. In other words, when the word “revenue” is placed in the external category for accounting, and the word “revenue” is found in the unstructured document, it is recognized that the text of the unstructured document is relevant to accounting. A “hit” refers to a match between a word or phrase in the external category and a word or phrase in the unstructured document. Upon finding a “hit”, the word “revenue” creates an entry in a separate table. The data found in the separate table may include the name of the source document, the word that has been matched (or “hit”), and the external category, for example.

As an example, suppose the word “revenue” is found in an external category for accounting. Suppose an unstructured document known as ABCDE123 is being analyzed. The resulting hit would produce a record in a list or a database where the entry would look as follows: “doc name—ABCDE123; matched word—revenue; external category—accounting.”

Note that the same word may appear in multiple external categories. For example the word “revenue” may appear in the external categories of accounting, finance, sales, Sarbanes Oxley, and so forth. External categories can come from anywhere. There are no limitations or boundaries for the source of data found in any external data category.

The output of the “hits” or matches may be sent to a table or a list. The table can be in the form of a simple list. The table can be in a database, for example. The structure of the database may be very similar to a relational flat file. Once the simple list or database is created, the data is then available for processing in the structured environment.

The simple output table tells the viewer where in the unstructured world there is data that relates to the different external categories. The editing pass of the unstructured data can use multiple external categories of data. There is no theoretical limit as to how many external categories that can be used (e.g., all at the same time) in editing and scanning the unstructured data.

In another embodiment, the external categories of data can be in different languages. One external category can be in French, another external category can be in English, and another external category can be in Spanish. There is no language limitation on the different languages that can be mixed together.

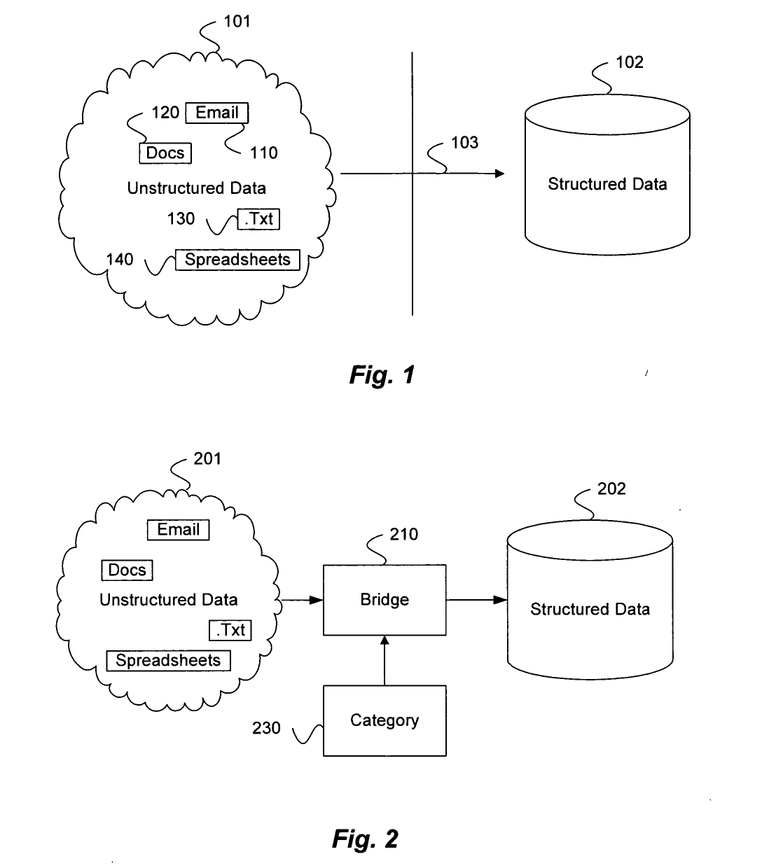

FIG. 1 illustrates the two environments—the structured environment 102 and the unstructured environment 101. Features and advantages of the present invention include analyzing unstructured data 101 and converting the unstructured data into a structured format for movement into the structured environment 102 as shown by arrow 103. The structured environment 101 is made up of records, tables, attributes, data elements, and database management systems. The unstructured environment is made up of emails 110, documents 120, spreadsheets 140, telephone conversations, and other forms of textual data (e.g., .txt files 130), for example.

FIG. 2 illustrates a bridge 210 between the two environments. The bridge 210 is quite useful in that applications can be written that incorporate both kinds of data. The bridge is very difficult to build because of the extremely different nature of data in both environments. Unstructured data 201 simply has no structure. On the other hand structured data 202 requires structure. Therefore the bridge between the two worlds is much more complex than just a mere search engine. Embodiments of the invention include a bridge 210 that reads unstructured data sources and receives one or more categories 230, as described above, for creating structured data from unstructured data.

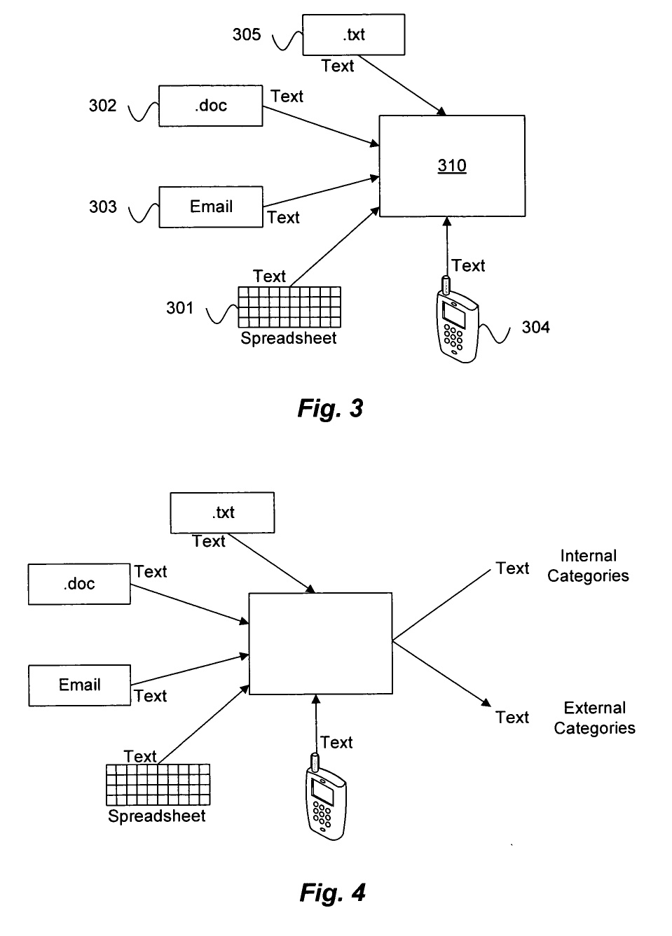

FIG. 3 shows that the foundation software 310 can read unstructured data from many sources. Text may be gathered from different sources and converted into a structured format. Typical sources are spreadsheets 301, documents 302, emails 303, telephone conversations that have been transcribed 304, or other textual sources (e.g., .txt files 305). In the case of telephone conversations, telephone discussions are usually taped. Then the tapes are transcribed into an electronic textual form. The input seen by the foundation software is the textual form of data. By the time the data arrives at the foundation software, it is just textual data that has happened to originate from different sources.

FIG. 4 shows that the output of foundation processing can be divided into two classes. As illustrated in this example, text may be gathered from many different sources. Once text has been gathered, it can be used to create internal categories 401 of data. Internal data is data and analysis of that data that is generated entirely from the unstructured sources. Alternatively, the data can be associated with an external category. External data is data that relates to one or more external categories of data. There may be no intersection of data between unstructured text or there may be a considerable intersection. The amount of the intersection depends on what the unstructured data relates to and what external categories are used.

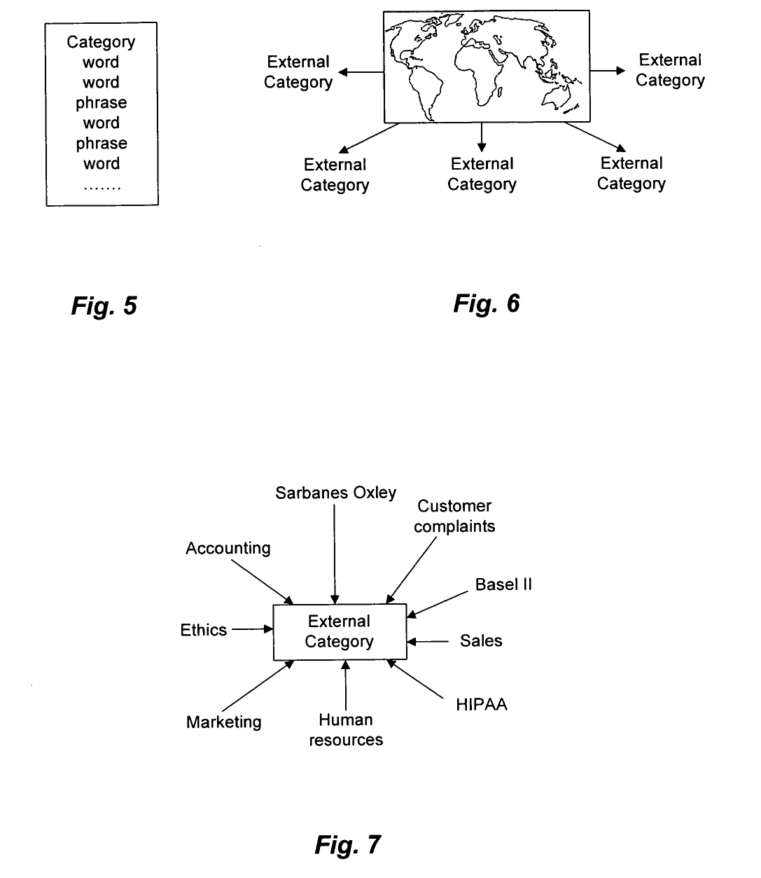

FIG. 5 illustrates an external category 500. An external category may include a category name and words and phrases that relate to the category. In addition, the words and phrases inside the external category can have their own internal structuring within the external category.

FIG. 6 illustrates that external categories of words and phrases can come from anywhere. They can come from different geographies. They can come from different disciplines. They can come from different departments. There simply is no boundary that limits where the sources of external categories can come from.

FIG. 7 illustrates some typical external categories of data. Categories may include accounting, ethics, HIPAA (i.e., a national health care information standard), marketing, human resources, customer companies, Basel II (i.e., an international financial information standard), sales, or Sarbanes-Oxley, for example.

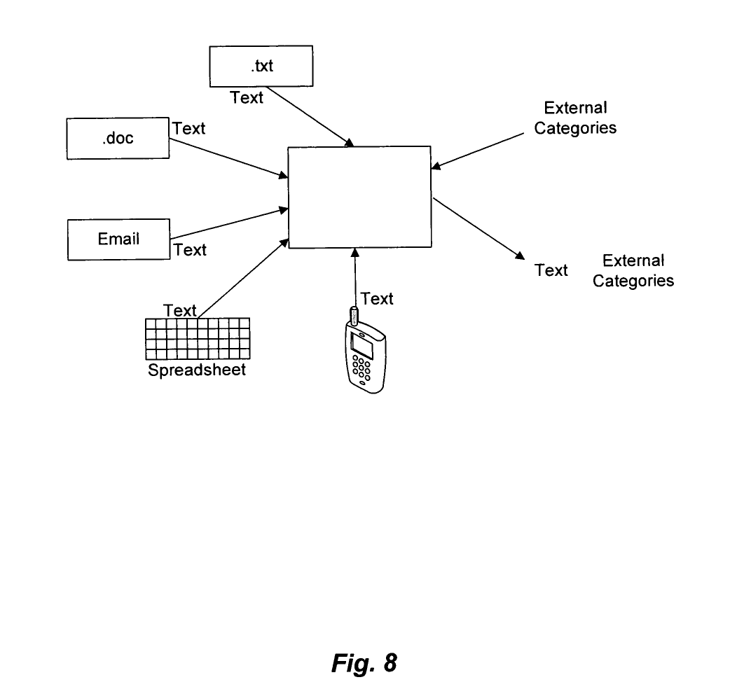

FIG. 8 shows two example ways that foundation editing and processing can be done. One way is to do editing directly at the point of reading the unstructured data. The other way is indirectly, after the unstructured data is “screened” and “filtered.” In either case, external category comparisons can be done in conjunction with other processing against the unstructured data.

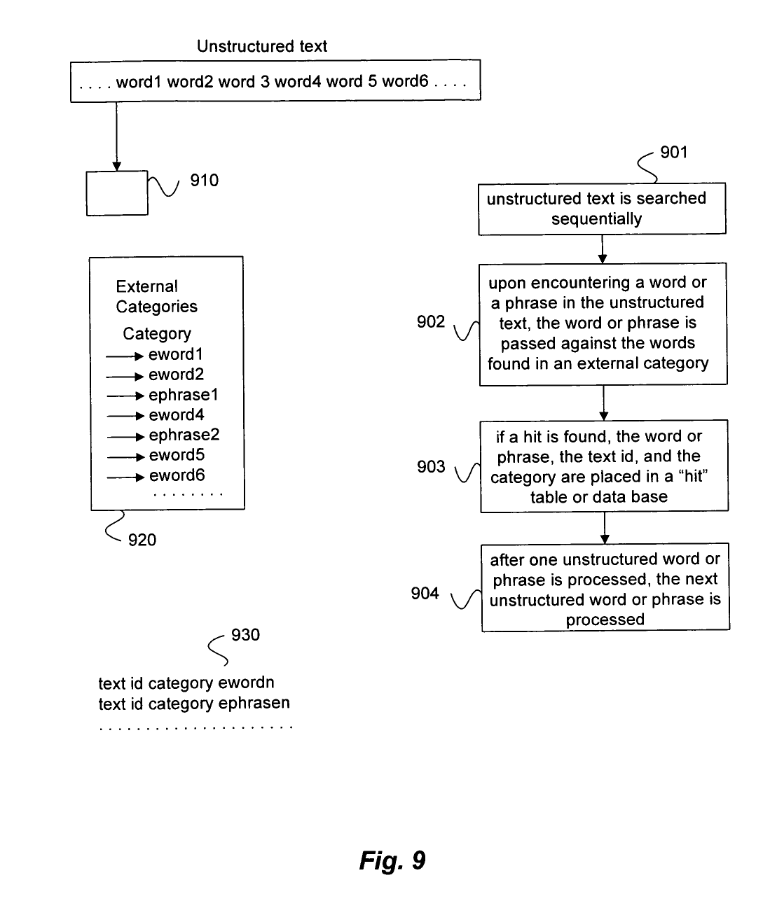

FIG. 9 shows the dynamics of a direct comparison of unstructured data to the contents of the external category. In the case shown, the unstructured data is read a word or phrase at a time. The unstructured word that has been read is compared with the words and phrases in the external category. If there is no match, nothing happens. But if there is a match, an output record is written. The output record may include the identification of the document, the word on which there has been a match, and the name of the external category. The process may be repeated for each of the unstructured words. As exemplified in FIG. 9, bridge software 910 receives unstructured data words or phrases. Steps of a direct external category search may begin at 901, where unstructured data is searched sequentially. As shown at 902, upon encountering a word or phrase in the unstructured text, the word or phrase is passed against the words or phrases found in an external category 920. At 903, if a hit is found, the word or phrase, the text id (e.g., identifying the unstructured document), and the category may be placed in a “hit” table or database. At 904, after one unstructured word or phrase is processed, the next unstructured word or phrase is processed, for example.

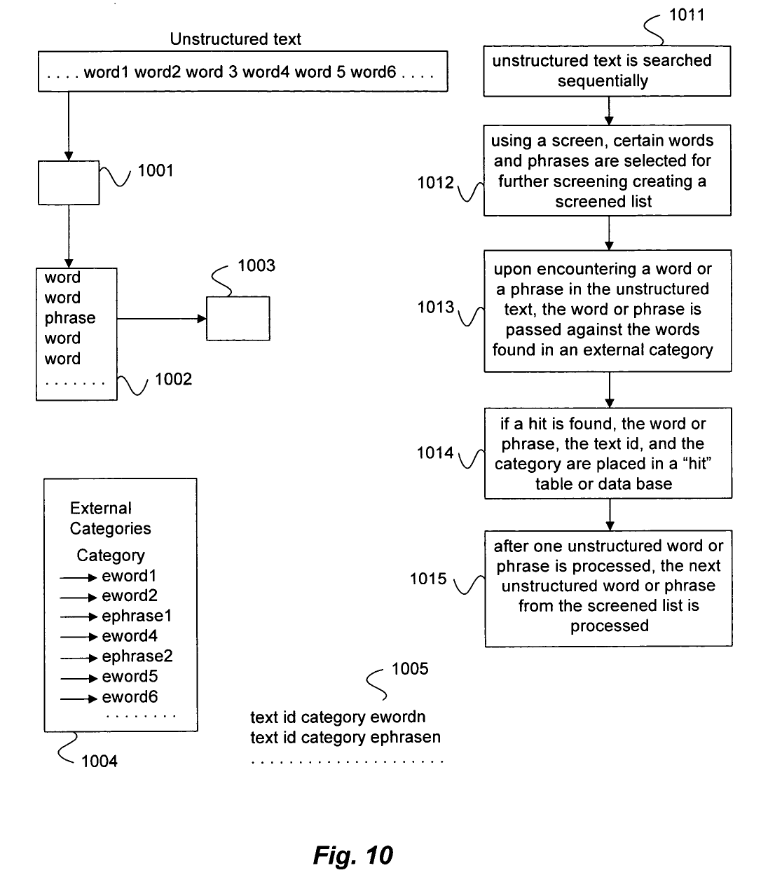

FIG. 10 shows an indirect usage of the foundation software. In the indirect case the unstructured document is read word by word by software component 1001. The data may be read and sent to a temporary or work file 1002, for example. The unstructured data is edited for other kinds of processing and may then be placed in the work file. The data may then be re-read and processed against the words and phrases found in the external category 1004 of data by software component 1003. When a hit is found an output record 1005 may be written to the output file or data base. As exemplified in FIG. 10, the steps of an indirect external category search include sequentially searching unstructured text at 1011. At 1012, a screen may be used for selecting certain words or phrases for further screening—created a screened list. At 1013, upon encountering a word or phrase in the unstructured text, the word or phrase is passed against the words found in an external category. At 1014, if a hit is found, the word or phrase, the text id, and the category are placed in a “hit” table or database. At 1015, after one unstructured word or phrase is processed, the next unstructured word or phrase from the screened list is processed. It is to be understood that the above two examples showing direct and indirect processing are only examples. Features and embodiments of the present invention may be implemented into systems in a variety of different ways.

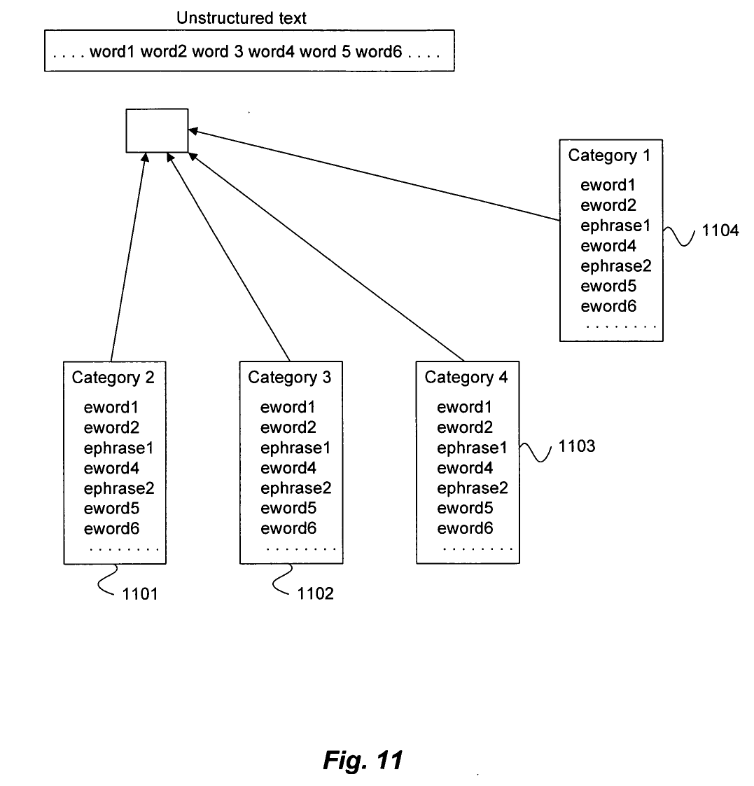

FIG. 11 shows that multiple external categories of words and phrases 1101-1104 can be used for editing. It is not necessary to have a single external category of data to be used for editing purposes. Thus, there can be one or more external categories used against the unstructured data. The same word may appear in more than one external category.

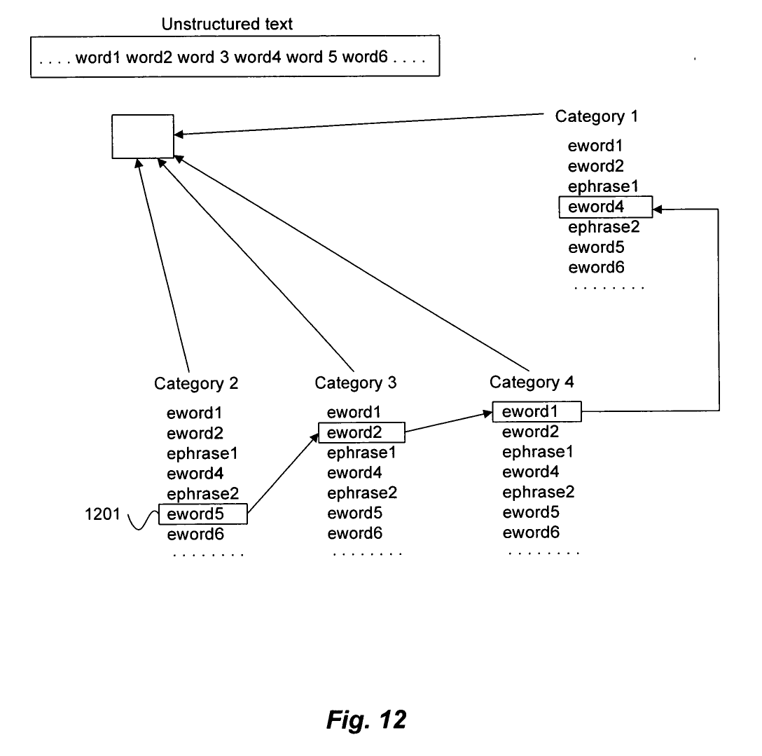

FIG. 12 shows that the same word or phrase can appear in multiple external categories. In this example, the same word 1201 may appear in category 2 (“eword5”), category 3 (“eword2”), category 4 (“eword1”), and category 1 (“eword4”). The words or phrases may appear in different positions in the different categories, for example.

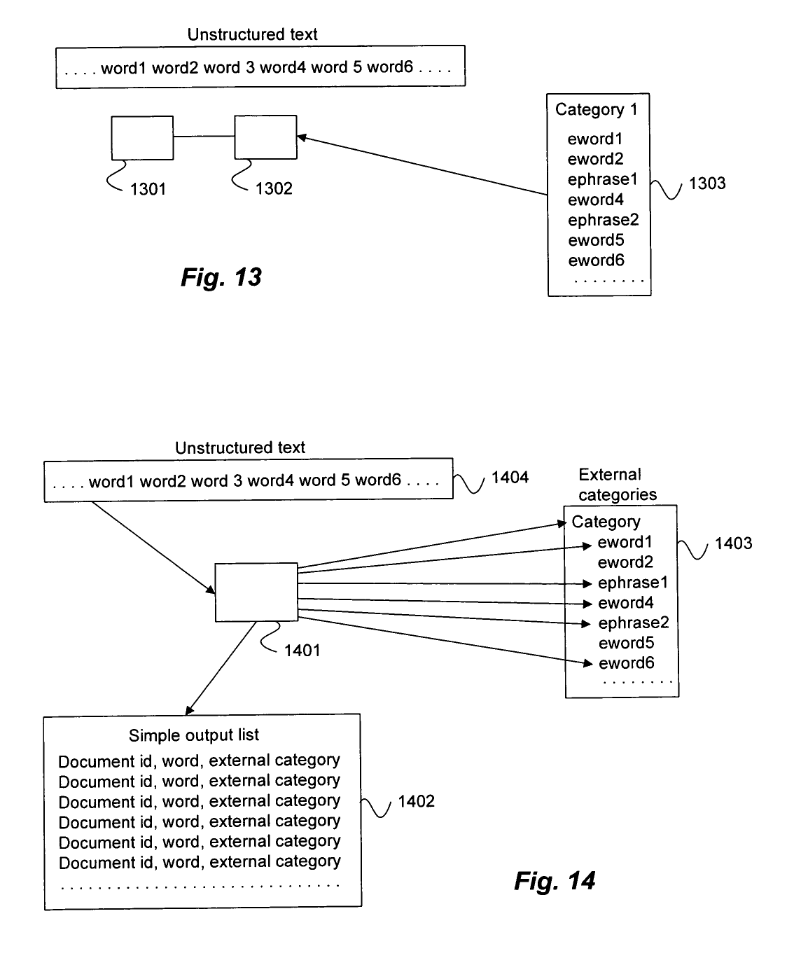

FIG. 13 shows that editing based on external categorization can be used in conjunction with other editing and manipulation of unstructured data and text. In this example, a first software component 1301 may perform some processing of the unstructured data before bridge component 1302 generates records based on category 1303. Other types of processing may occur before, after, or in parallel with categorization processing, for example.

FIG. 14 shows the output of foundation processing using external categories as a basis for scanning data. In this example, software component 1401 receives unstructured text 1404 and external category 1403. The output is a structured list 1402, which may be a flat file, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of processing unstructured data comprising:
specifying a first plurality of words or phrases corresponding to a category;
accessing unstructured data comprising a second plurality of words or phrases;
comparing the unstructured data against each of the specified words or phrases;
associating at least a portion of the unstructured data with the category if one or more of the specified words or phrases matches at least one word or phrase in the portion of the unstructured data; and
generating a structured data output.

2. The method of claim 1 wherein the structured data output comprises an identification of an unstructured document, a matching word or phrase, and a name of the category.

3. The method of claim 1 wherein the structured data output comprises at least a portion of the unstructured data, at least one matching word or phrase in the unstructured data and the category.

4. The method of claim 1 wherein the structured data output is a structured record.

5. The method of claim 1 wherein the structured data output is generated in a list.

6. The method of claim 1 wherein the structured data output is generated in a database.

7. The method of claim 1 wherein the structured data output is generated in a table.

8. The method of claim 1 further comprising reading the unstructured data into a file, and accessing the unstructured data from the file.

9. The method of claim 1 further comprising reading the unstructured data directly from the unstructured data source.

10. The method of claim 1 wherein the unstructured data comprises a plurality of emails.

11. The method of claim 1 wherein the unstructured data comprises a plurality of spreadsheets.

12. The method of claim 1 wherein the unstructured data comprises plurality of transcribed telephone conversations.

13. The method of claim 1 wherein the unstructured data comprises one or more electronic files comprising a plurality of words or phrases.

14. The method of claim 1 wherein the unstructured data comprises textual data.

15. The method of claim 1 wherein the category comprises accounting.

16. The method of claim 1 wherein the category comprises finance.

17. The method of claim 1 wherein the category comprises sales.

18. The method of claim 1 wherein the category comprises Sarbanes Oxley.

19. The method of claim 1 wherein the category comprises manufacturing.

20. The method of claim 1 wherein the category comprises marketing.

21. The method of claim 1 wherein the category comprises human resources.

22. The method of claim 1 wherein the category is generated from the unstructured data.

23. The method of claim 1 wherein the category is an external category.

24. The method of claim 1 wherein the category comprises a name and a plurality of associated words or phrases.

25. A method of processing unstructured data comprising:
specifying one or more categories, each category comprising a first plurality of words or phrases;
reading unstructured data comprising a second plurality of words or phrases;
comparing the unstructured data against the words or phrases in each category;
associating at least a portion of the unstructured data with at least one category if one or more words or phrases in the at least one category matches at least one word or phrase in the portion of the unstructured data; and
generating a structured data output.

26. The method of claim 25 wherein the structured data output comprises an identification of an unstructured document, a matching word or phrase, and a name of the category.

27. The method of claim 25 wherein the structured data output comprises at least a portion of the unstructured data, at least one matching word or phrase in the unstructured data and the category.

28. The method of claim 25 wherein the structured data output is a structured record.

29. The method of claim 25 wherein the structured data output is generated in a list.

30. The method of claim 25 wherein the structured data output is generated in a database.

31. The method of claim 25 wherein the structured data output is generated in a table.

32. The method of claim 25 further comprising reading the unstructured data into a file, and accessing the unstructured data from the file.

33. The method of claim 25 further comprising reading the unstructured data directly from the unstructured data source.

34. The method of claim 25 wherein the unstructured data comprises a plurality of emails.

35. The method of claim 25 wherein the unstructured data comprises a plurality of spreadsheets.

36. The method of claim 25 wherein the unstructured data comprises a plurality of transcribed telephone conversations.

37. The method of claim 25 wherein the unstructured data comprises one or more electronic files comprising a plurality of words or phrases.

38. The method of claim 25 wherein the unstructured data comprises textual data.

39. The method of claim 25 wherein the category comprises accounting.

40. The method of claim 25 wherein the category comprises finance.

41. The method of claim 25 wherein the category comprises sales.

42. The method of claim 25 wherein the category comprises Sarbanes Oxley.

43. The method of claim 25 wherein the category comprises manufacturing.

44. The method of claim 25 wherein the category comprises marketing.

45. The method of claim 25 wherein the category comprises human resources.

46. The method of claim 25 wherein the category is generated from the unstructured data.

47. The method of claim 25 wherein the category is an external category.

48. The method of claim 25 wherein the category comprises a name and a plurality of associated words or phrases.

49. A computer implemented system for processing unstructured data comprising:
means for specifying a first plurality of words or phrases corresponding to a category;
means for accessing unstructured data comprising a second plurality of words or phrases;
means for comparing the unstructured data against each of the specified words or phrases;
means for associating at least a portion of the unstructured data with the category if one or more of the specified words or phrases matches at least one word or phrase in the portion of the unstructured data; and
means for generating a structured data output.
